(19) United States
(12) Patent Application Publication
(10) Pub. No.: US 2018/0169849 A1
(43) Pub. Date: Jun. 21, 2018

(54) Shoed Hydraulic Hammer Piston

(71) Applicant: Caterpillar Inc., Peoria, IL (US)

(72) Inventor: Steven B. Ellis, Hewitt, TX (US)

(73) Assignee: Caterpillar Inc., Peoria, IL (US)

(21) Appl. No.: 15/380,446

(22) Filed: Dec. 15, 2016

(51) Int. Cl. B25D 17/06; B25D 9/04

(52) U.S. Cl. CPC B25D 17/06; B25D 9/04; B25D 2217/0023; B25D 2250/351; B25D 2222/33; B25D 2250/361; B25D 2222/27

(57) ABSTRACT

A piston for a hydraulic hammer assembly is provided. The piston may include an elongate member extending from a distal end to a proximal end and having a first outer diameter, a flange disposed on the elongate member and having a second outer diameter greater than the first outer diameter, and a non-ferrous shoe radially disposed on the flange.

### TECHNICAL FIELD

The present disclosure relates generally to hydraulic tools, and more particularly, to pistons for hydraulic hammer assemblies.

### BACKGROUND

Hydraulic hammers are one of an assortment of work tools that may be attached to the boom of an excavator, backhoe loader, skid steer, or other suitable machines for breaking large rocks, concrete, and the like. In a typical application, the hydraulic hammer is mounted to the machine boom in place of a bucket, and connected to the hydraulic system of the machine. When activated, high pressure fluid is supplied to the hydraulic hammer to drive a reciprocating piston into and out of contact with an impact end of a work tool partially enclosed in a housing of the hydraulic hammer assembly. In many conventional arrangements, the high pressure fluid is fed into chambers formed between flanges or shoulders of the piston and a cylinder wall or sleeve, which enable the piston to be pneumatically actuated, into and out of contact with the work tool.

A common concern and costly maintenance item in hydraulic hammers relate to scoring between the piston and the cylinder wall or sleeve. In particular, scoring may occur when direct contact between the piston and the cylinder wall or sleeve degrades the respective surfaces over time. Such scoring not only adversely affects the consistency of the reciprocating motion of the piston relative to the cylinder, but also compromises the fluid chambers formed between the flanges of the piston and the cylinder wall. In order to reduce such susceptibility to scoring, the flanges, or other surfaces of the piston which make direct contact with the cylinder wall, are polished and/or hardened. While polishing can slow the onset of scoring, scoring is still likely occur. When scoring does occur, the piston will likely need to be replaced or repaired, which can be costly and time consuming.

One possible solution to scoring is disclosed in Chinese Patent Application No. CN 101020309A. The '309 application discloses a retainer that is formed of a softer material and provided inside one section of the cylinder wall. While the retainer may alleviate some scoring of the piston, the retainer is localized to only one end of the cylinder body and still leaves other surfaces of the piston exposed to scoring. Furthermore, as the retainer is formed of a softer material, it is likely more prone to wear. However, the retainer is also integrally formed within the cylinder wall and not readily replaceable or reparable. Thus, when the retainer wears, the cylinder body will likely need to be replaced in its entirety, or at the least, substantially disassembled in order to access the retainer for repair. The costs and time associated with replacing or repairing the cylinder body may be comparable to conventional maintenance costs and time associated with replacing or repairing scored pistons.

In view of the foregoing, a need exists for a simplified solution for reducing the onset of scoring and the adverse effects associated therewith. In particular, there is a need for an improved actuation assembly, which not only protects both the piston and the cylinder from substantial scoring, but also allows for timely and economical repairs or replacements if scoring still results. A need also exists for a solution that effectively guards the piston and cylinder wall of a hammer assembly, while resisting degradation of pneumatic chambers therein. The present disclosure is directed at addressing one or more of the deficiencies and disadvantages set forth above. However, it should be appreciated that the solution of any particular problem is not a limitation on the scope of this disclosure or of the attached claims except to the extent expressly noted.

### SUMMARY OF THE DISCLOSURE

In one aspect of the present disclosure, a piston for a hydraulic hammer assembly is provided. The piston may include an elongate member extending from a distal end to a proximal end and having a first outer diameter, a flange disposed on the elongate member and having a second outer diameter greater than the first outer diameter, and a non-ferrous shoe radially disposed on the flange.

In another aspect of the present disclosure, a non-ferrous shoe for a hydraulic hammer piston is provided. The non-ferrous shoe may include at least two arcuate members formed of a non-ferrous material sized to sealably fit around an outer diameter of the piston, and one or more fasteners configured removably couple the arcuate members to the outer diameter of the piston.

In yet another aspect of the present disclosure, a method of providing a shoed piston for a hammer assembly having a cylindrical chamber is provided. The method may include providing a piston having at least one flange formed of a ferrous material, providing one or more arcuate members formed of a non-ferrous material sized to sealably fit around an outer diameter of the flange and within an inner diameter of the cylindrical chamber, and removably installing the arcuate members on the outer diameter of the flange to form a non-ferrous shoe.

These and other aspects and features will be more readily understood when reading the following detailed description in conjunction with the accompanying drawings.

### BRIEF DESCRIPTION OF THE DRAWINGS

FIG. 1 is an isometric view of a work machine having a hydraulic hammer actuation assembly of the present disclosure;

FIG. 2 is an exploded view of one exemplary embodiment of a hydraulic hammer actuation assembly of the present disclosure;

FIG. 3 is a perspective view of one exemplary shoed piston of the present disclosure;

FIG. 4 is a perspective view of one exemplary non-ferrous shoe of the present disclosure;

FIG. 5 is a perspective view of another exemplary non-ferrous shoe of the present disclosure; and

FIG. 6 is a flow diagram of one exemplary method of providing a shoed piston of the present disclosure.

While the following detailed description is given with respect to certain illustrative embodiments, it is to be understood that such embodiments are not to be construed as limiting, but rather the present disclosure is entitled to a scope of protection consistent with all embodiments, modifications, alternative constructions, and equivalents thereto.

### DETAILED DESCRIPTION

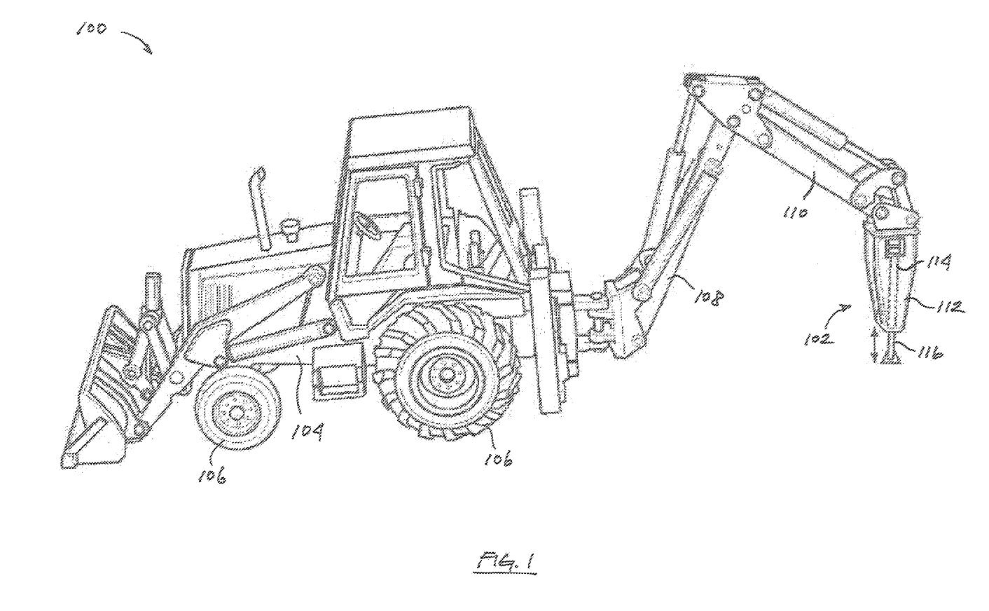

Referring to FIG. 1, one exemplary embodiment of a machine 100 having a hammer assembly 102 is provided. As shown, the machine 100 may generally include a frame 104 that is movably supported by one or more wheels or traction devices 106. Although depicted in the form of a backhoe loader, it will be understood that the machine 100 in FIG. 1 may encompass any other machine configured to perform work associated with a particular industry, such as the mining or construction industry. For example, the machine 100 may alternatively be an excavator, a skid steer loader, or the like. The hammer assembly 102 may be pivotally coupled to or extended from the frame 104 of the machine 100 through a boom 108 and a stick 110. The boom 108 and the stick 110 may link the hammer assembly 102 to the frame 104 in a manner enabling the hammer assembly 102 to be lifted, curled, swung left to right, and/or moved in and out relative to the machine 100. Although only one linkage arrangement is shown in FIG. 1, it will be understood that alternative linkage arrangements and other types and/or ranges of movement are also possible.

As shown in FIG. 1, the hammer assembly 102 may generally include a housing 112, an actuator arrangement 114, and a work tool 116. In particular, the housing 112 may be configured to support the actuator arrangement 114 and the work tool 116 on the distal or working end of the stick 110, and protect at least part of the actuator arrangement 114 from large debris. The actuator arrangement 114 may be disposed within the housing 112 and operatively coupled to the work tool 116. For example, the actuator arrangement 114 may be hydraulically and/or mechanically arranged to cause a reciprocal action. Correspondingly, the work tool 116 may include any tool that can be operated using the reciprocal action. For instance, the work tool 116 may include a hammer, chisel, or the like. The work tool 116 may also be removably attached to the distal or working end of the actuator arrangement 114, and configured to retractably extend from the housing 112. Although shown as a hammer, it will be understood that the work tool 116 may alternatively encompass any other tool suited for use with the actuator arrangement 114.

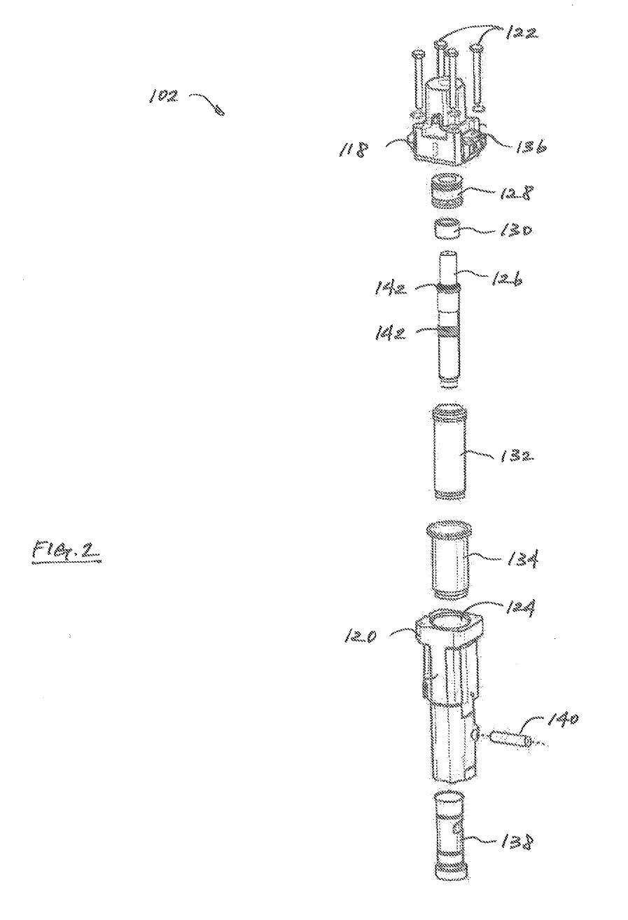

Turning to FIG. 2, one exemplary embodiment of an actuator arrangement 114 for a hydraulic hammer assembly 102 is provided. As shown, the actuator arrangement 114 may generally include a head 118 and an actuator body 120, which are mounted within the housing 112 and configured to support the work tool 116. The head 118 and the actuator body 120 may be sealably coupled together using head bolts 122, or the like, and configured to form a hydraulic cylindrical chamber 124 extending therethrough. The cylindrical chamber 124 may enclose a piston 126 that is reciprocally disposed therein. In other refinements, the cylindrical chamber 124 may additionally include an arrangement of seal carriers 128, valves 130, sleeves 132, accumulator membranes 134, or any other arrangement used in the art to promote hydraulic efficiency and performance. Still further, the head 118 may include an inlet 136 in selective communication with a hydraulic fluid supply, and the actuator body 120 may include a connector 138 and a connector pin 140 configured to releasably couple the actuator arrangement 114 to a work tool 116.

During operation of the actuator arrangement 114 of FIG. 2, pressurized hydraulic fluid is introduced into the cylindrical chamber 124 via the inlet 136. Moreover, the hydraulic fluid is pressurized between the respective seals of the head 118, actuator body 120, the cylindrical chamber 124 or sleeves 132, and one or more flanges 142 of the piston 126 in a manner which causes the piston 126 to selectively reciprocate within the cylindrical chamber 124. Specifically, changes in the hydraulic pressure within the cylindrical chamber 124 cause the piston 126 to engage the work tool 116, such as move away from the head 118 and toward the actuator body 120, or disengage the work tool 116, such as move away from the actuator body 120 and toward the head 118. In order to reduce scoring between the cylindrical chamber 124 and the piston 126 without adversely affecting the integrity of the seal therebetween, the piston 126 may be provided with one or more shoes 144 radially disposed on each of the flanges 142 of the piston 126.

Referring now to FIG. 3, one exemplary embodiment of a shoed piston 126 for a hammer assembly 102 is provided. As shown, the piston 126 may include an elongate member 146 extending from a distal end 148 to a proximal end 150 of the piston 126, one or more flanges 142 disposed along the elongate member 146, and a shoe 144 radially disposed on each of the flanges 142. Although the elongate member 146 may include sections of varying diameter, a maximum or outermost diameter of the elongate member 146 may be defined as d₁. The outer diameter of the flanges 142 may be defined as d₂, which may be greater than the outermost diameter d₁ of the elongate member 146. Furthermore, the shoes 144 are disposed over the flanges 142, and thus, may have an outer diameter d₃ that is greater than the outermost diameter d₁ of the elongate member 146 and the outer diameter d₂ of the flanges 142. Moreover, each of the shoes 144 may be configured to fit and form a substantial seal between the elongate member 146 and the cylindrical chamber 124, and thus, sized to approximate an inner diameter d₄ of the cylindrical chamber 124.

Still referring to FIG. 3, each of the shoes 144 may be configured not only to protect metal-on-metal contact points between the piston 126 and the cylindrical chamber 124 and to retain the seal therebetween, but also to promote ductility into scratches that may form along the inner diameter of the cylindrical chamber 124. In particular, each of the shoes 144 may be formed of materials that are more malleable than the respective materials of the cylindrical chamber 124 and the piston 126. For instance, typical hammer assemblies 102 which employ cylindrical chambers 124 and pistons 126 formed of a ferrous metal, may be fitted with shoes 144 formed of a non-ferrous metal, such as copper, brass, or the like. Although intended as a dispensable item and designed to wear at a faster rate than the cylindrical chamber 124 and the piston 126, the shoes 144 may still be formed of a material that is sufficiently rigid to withstand hydraulic pressures typical of a hammer assembly 102 and capable of protecting the actuator arrangement 114 from scoring.

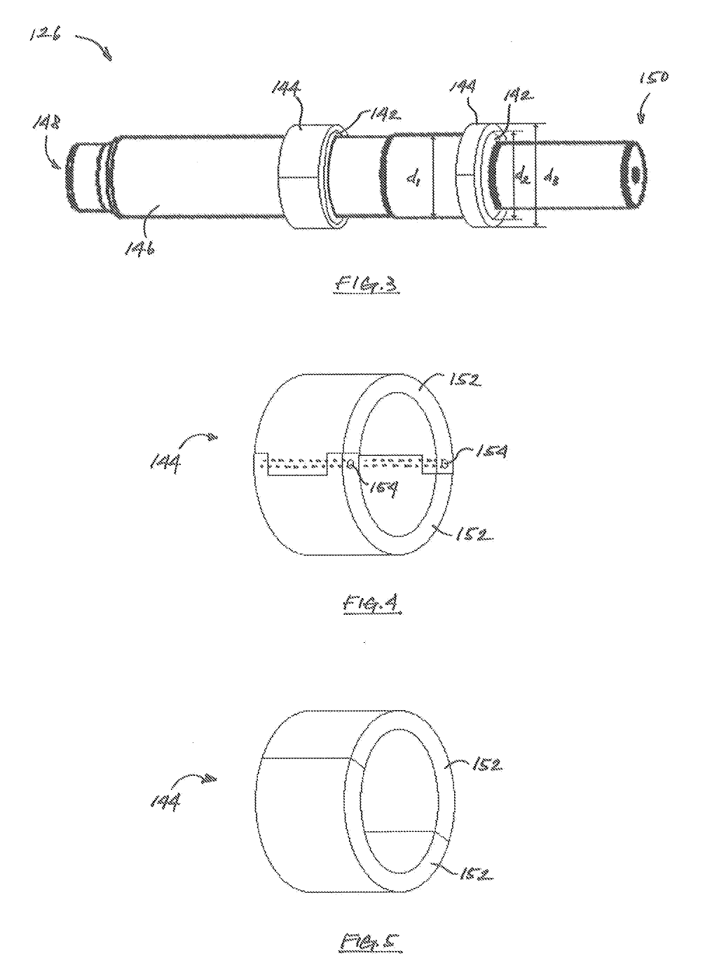

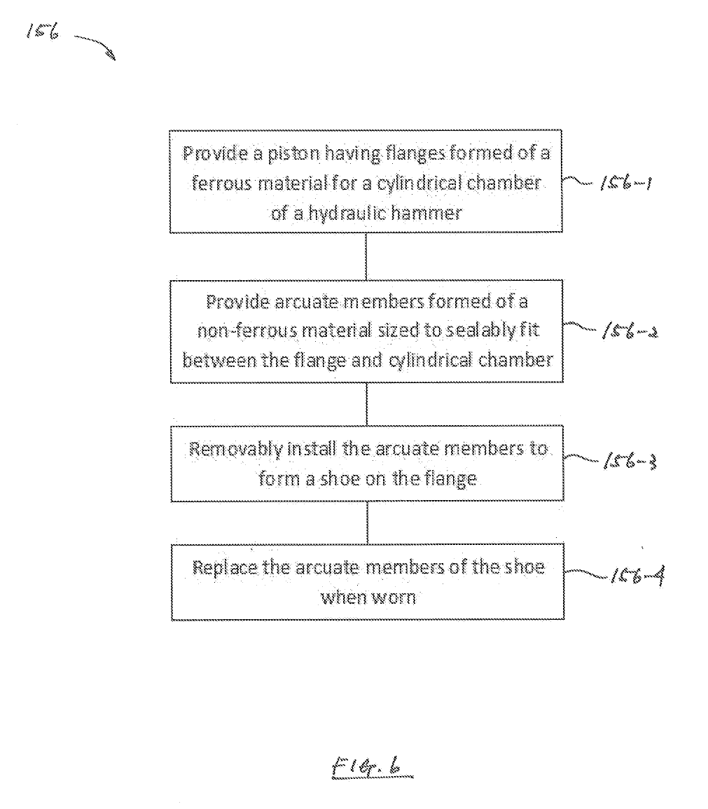

Turning to FIGS. 4 and 5, each of the shoes 144 may be composed of one or more arcuate members 152 that are removably installed on the outer diameter d₂ of the respective flange 142. Each of the arcuate members 152 may be cylindrically shaped such that, when joined together, the flange 142 is substantially covered and sealed against the inner diameter d₄ of the cylindrical chamber 124. As shown, the arcuate members 152 may be removably installed onto the flange 142 using one or more fasteners 154, such as screws, pins, lugs, latches, hinges, tabs, clips, and the like. In FIG. 4, for example, the fasteners 154 may be configured to removably couple the arcuate members 152 to one another. In FIG. 5, for example, the fasteners 154 may be configured to removably couple each arcuate member 152 directly to the flange 142. In either configuration, the arcuate members 152 and/or the fasteners 154 may be configured to maintain the integrity and consistency of the seal between the cylindrical chamber 124 and the piston 126. For example, screw-type fasteners 154 may be countersunk so as to be flush with the surface of the shoe 144.

In other embodiments, the arcuate members 152 and the fasteners 154 may incorporate a combination of the arrangements of FIGS. 4 and 5. For example, the fasteners 154 may be configured to couple each of the arcuate members 152 to one another and to the flange 142. In alternative embodiments, the arcuate members 152 may omit fasteners 154 and incorporate an interlocking design to secure the arcuate members 152 to one another. In further alternatives, each of the flanges 142 may incorporate threaded designs, ribbed designs, or other interlocking designs configured to removably receive a shoe 144 thereon and promote a seal therebetween. For instance, the corresponding surfaces of the shoes 144 and the flanges 142 may be threaded in a manner which creates or promotes a seal therebetween sufficient to maintain hydraulic pressure within the cylindrical chamber 124. The shoe 144 may be composed of a single, ring-shaped arcuate member 152 or a plurality of arcuate members 152. In still other alternative embodiments, the shoes 144 may be permanently installed onto the outer surface of the flanges 142. For example, a liquid metal spray, or any other suitable technique may be used to permanently apply a consistent, non-ferrous metal layer onto a ferrous surface of each flange 142. While only certain embodiments are disclosed, other arrangements will be apparent to those of skill in the art.

### INDUSTRIAL APPLICABILITY

In general, the present disclosure finds utility in various industrial applications related to mining, construction, or any other application involving hydraulic hammers or chisels for breaking large rocks, concrete, and the like. For example, the present disclosure may be implemented in excavators, backhoe loaders, skid steer loaders, and the like. In particular, by providing a non-ferrous shoe along the metal-on-metal contact points within a hydraulic hammer assembly, scoring and related damage are reduced between the piston and the associated cylindrical chamber. Additionally, providing more malleable metals at the points of contact promotes ductility into scratches, which further supports the integrity of the hydraulic seals. While strong enough to protect the piston and the cylindrical chamber, the shoes are also sufficiently forgiving to reduce piston lock-up conditions and related cylinder failures. Furthermore, by enabling the shoes to be replaceable and reducing damage to the piston and the cylindrical chamber, maintenance or repair costs, as well as the downtime needed for repairs are substantially reduced.

Turning now to FIG. 6, one exemplary method 156 of providing a shoed piston 126 for a cylindrical chamber 124 is provided. As shown, the method 156 in block 156-1 may initially provide a piston 126 for a hammer assembly 102 that includes at least one flange 142 formed of a ferrous metal. As shown in FIG. 3, for example, the piston 126 may generally have a maximum or outermost diameter d₁, and a flange 142 radially extending therefrom with an outer diameter d₂ that is greater than the outermost diameter d₁ of the piston 126. The method 156 in block 156-2 may provide a shoe 144 having one or more arcuate members 152 as shown in FIGS. 4 and 5 formed of a non-ferrous metal sized to sealably fit around the outer diameter d₂ of the flange 142 and within an inner diameter d₄ of the cylindrical chamber 124. Moreover, the shoe 144 may have an outer diameter d₃ that is greater than the second outer diameter d₂ and substantially approximating the inner diameter d₄ of the cylindrical chamber 124.

Still referring to FIG. 6, the method 156 in block 156-3 may removably install the arcuate members 152 of the shoe 144 onto the outer diameter d₂ of the flange 142. Although various schemes may be used, the arcuate members 152 may be coupled to one another and/or coupled directly onto the flange 142 using one or more removable fasteners 154 as shown in FIGS. 4 and 5, or other arrangements. As each of the arcuate members 152 and the removable fasteners 154 are removable, the installed shoe 144 may be replaceable once worn according to block 156-4 of the method 156. Although the method 156 provides a piston 126 with a replaceable shoe 144, permanent shoes 144 may also be provided. For instance, rather than removably installing arcuate members 152 using fasteners 154, a layer of a non-ferrous metal may be permanently applied along the outer surface of each flange 142, such as via a liquid metal spray technique, or the like. When a permanent shoe 144 is worn, a new layer of a non-ferrous metal may be re-applied onto the worn shoe 144, or the piston 126 may be replaced with a new shoed piston 126.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A piston for a hydraulic hammer assembly, the piston comprising:
an elongate member extending from a distal end to a proximal end and having a first outer diameter;
a flange disposed on the elongate member and having a second outer diameter greater than the first outer diameter; and
a non-ferrous shoe radially disposed on the flange.

2. The piston of claim 1, wherein the elongate member is configured to reciprocate within an inner diameter of a ferrous cylindrical chamber, the non-ferrous shoe being composed of one or more arcuate members sized to sealably fit around the second outer diameter of the flange and within the inner diameter of the cylindrical chamber.

3. The piston of claim 1, wherein the non-ferrous shoe includes two or more arcuate members that are removably installed on the second outer diameter of the flange.

4. The piston of claim 3, wherein the arcuate members are coupled to one another using one or more removable fasteners.

5. The piston of claim 1, wherein the non-ferrous shoe has a third outer diameter greater than the second outer diameter.

6. The piston of claim 1, further comprising a second flange proximally disposed relative to the flange, and a second non-ferrous shoe radially disposed on the second flange.

7. The piston of claim 1, wherein the non-ferrous shoe is permanently installed on the flange.

8. The piston of claim 7, wherein the non-ferrous shoe is applied on the second outer diameter of the flange using a liquid metal spray.

9. A non-ferrous shoe for a hydraulic hammer piston, the non-ferrous shoe comprising:
at least two arcuate members formed of a non-ferrous material sized to sealably fit around an outer diameter of the piston; and
one or more fasteners configured removably couple the arcuate members to the outer diameter of the piston.

10. The non-ferrous shoe of claim 9, wherein the arcuate members are formed of one of copper and brass.

11. The non-ferrous shoe of claim 9, wherein the arcuate members are sized to sealably fit around the outer diameter of a flange of the piston.

12. The non-ferrous shoe of claim 9, wherein the arcuate members are further sized to sealably fit between the outer diameter of the piston and an inner diameter of an associated cylindrical chamber.

13. The non-ferrous shoe of claim 12, wherein the fasteners are configured to maintain a seal between the outer diameter of the piston and the inner diameter of the cylindrical chamber.

14. The non-ferrous shoe of claim 9, wherein the fasteners are configured to removably couple the arcuate members to one another.

15. The non-ferrous shoe of claim 9, wherein the fasteners are configured to couple the arcuate members directly onto the outer diameter of the piston.

16. The non-ferrous shoe of claim 9, wherein the fasteners include one or more of screws, pins, lugs, latches, hinges, tabs, and clips.

17. A method of providing a shoed piston for a hammer assembly having a cylindrical chamber, the method comprising:
providing a piston having at least one flange formed of a ferrous material;
providing one or more arcuate members formed of a non-ferrous material sized to sealably fit around an outer diameter of the flange and within an inner diameter of the cylindrical chamber; and
removably installing the arcuate members on the outer diameter of the flange to form a non-ferrous shoe.

18. The method of claim 17, wherein the piston is provided with a first outer diameter, the flange is provided with a second outer diameter greater than the first outer diameter, and the non-ferrous shoe forms a third outer diameter greater than the second outer diameter and substantially approximating the inner diameter of the cylindrical chamber.

19. The method of claim 17, wherein the non-ferrous shoe includes two or more arcuate members that are coupled to one another to form the shoe.

20. The method of claim 17, wherein the arcuate members are removably installed on the outer diameter of the flange using one or more fasteners.
